(19) United States
(12) Patent Application Publication
(10) Pub. No.: US 2023/0128613 A1
(43) Pub. Date: Apr. 27, 2023

(54) ELECTRIC MOBILITY DEVICE, AND BRACKET USED FOR ASSEMBLY THEREOF

(71) Applicant: LG Electronics Inc., Seoul (KR)

(72) Inventors: Dong Geun LEE, Seoul (KR); Hyeok Jin GWON, Seoul (KR); Dae Hoon HONG, Seoul (KR)

(21) Appl. No.: 17/908,181

(22) PCT Filed: Feb. 25, 2021
(86) PCT No.: PCT/KR2021/002417

§ 371 Date: Aug. 30, 2022

(30) Foreign Application Priority Data
Mar. 16, 2020 (KR) 10-2020-0032292

(51) Int. Cl. B62K 11/02; B62J 43/10; B62J 43/20

(52) U.S. Cl. CPC B62K 11/02; B62J 43/10; B62J 43/20; B62K 2202/00

(57) ABSTRACT

An electric mobility apparatus is disclosed. The electric mobility apparatus may include a mid-frame assembly in which a bracket fastened to at least one component is mounted on an inner side, a front frame assembly having a portion inserted into a front face of the mid-frame assembly so as to be coupled to the mid-frame assembly, and a tail frame assembly having a portion inserted into a rear face of the mid-frame assembly so as to be coupled to the mid-frame assembly, wherein the bracket is fastened to both side faces inside the mid-frame assembly.

### TECHNICAL FIELD

Example embodiments of the present disclosure relate to an electric mobility apparatus and a bracket used for assembly thereof and relate to a device used when assembling an electric mobility apparatus including a non-integral front frame assembly, a mid-frame assembly, and a tail frame assembly.

### BACKGROUND ART

Recently, an electric mobility apparatus using electricity has been widely used for individuals moving in downtown areas. In general, the electric mobility apparatus may include a two-wheeled vehicle such as an electric bicycle, an electric scooter, and the like. The electric mobility apparatus may drive a motor using a built-in battery so that a user conveniently moves using the electric mobility apparatus.

KR 10-2019-0069807A relates to technology for improving safety in driving by reducing vibrations generated by a link member connecting a board assembly and a rear wheel portion. KR 10-1830161B1 relates to a footrest of an electric scooter that distributes a force, reinforces a strength, and stably accommodates a battery and a controller. KR 10-2017-0142009A relates to an electric scooter for achieving a stable balance by distributing and arranging a battery pack and various components including a link member in a board body. Such related documentations disclose a configuration using a separate link member, a configuration of a footrest including components therein, and a configuration to be folded but do not disclose a configuration for protecting internal components and improving convenience and strength of assembly as described herein.

### DISCLOSURE OF INVENTION

### Technical Goals

Example embodiments of the present disclosure are proposed to solve the above issues and disclose a bracket used when assembling an electric mobility apparatus including a front frame assembly, a mid-frame assembly, and a tail frame assembly which are formed not integrally. In this instance, internal components may need to be fastened. It may be difficult to fasten the internal components to the mid-frame assembly without fixing positions when the internal components are mounted on the mid-frame assembly. Thus, when a bracket for fixing the positions of the components is used, a convenience of assembly may be improved, which may lead to an increase in productivity of the electric mobility apparatus. Technical goals of the present disclosure are not limited as mentioned above and, although not mentioned, may include goals that can be clearly understood by those skilled in the art to which the present disclosure pertains, from the following description.

### Technical Solutions

To improve a convenience of assembly of an electric mobility apparatus and increase a productivity of the electric mobility apparatus, positions of components included in the electric mobility apparatus may be fixed. When the positions of the components are not fixed, the productivity of the electric mobility apparatus may be deteriorated due to the inconvenience of fastening. Accordingly, there is a desire for technology for improving the productivity of the electric mobility apparatus by fixing positions of components therein using a bracket.

To achieve the above-described goals, an electric mobility apparatus according to an example embodiment of the present disclosure includes a mid-frame assembly in which a bracket fastened to at least one component is mounted on an inner side, a front frame assembly having a portion inserted into a front face of the mid-frame assembly so as to be coupled to the mid-frame assembly, and a tail frame assembly having a portion inserted into a rear face of the mid-frame assembly so as to be coupled to the mid-frame assembly, wherein the bracket is fastened to both side faces inside the mid-frame assembly.

The bracket may include a first fastening arm that forms at least one uneven portion and is fastened to one side of the component inwardly, a second fastening arm that faces the first fastening arm, forms at least one uneven portion, and is fastened to the other side of the component inwardly, and a connector configured to connect the first fastening arm and the second fastening arm.

The bracket may include a connector disposed to face the rear face of the mid-frame assembly, a first plate formed to extend from the connector, a first bent portion that extends from the first plate and is bent toward an inner side of the bracket, a second plate formed to extend from the first bent portion, a second bent portion that extends from the second plate and is bent toward an outer side of the bracket, a third plate formed to extend from the second bent portion, a third bent portion that extends from the third plate and is bent toward the inner side of the bracket, and a fourth plate formed to extend from the third bent portion.

The fourth plate may include a protrusion that protrudes toward the outer side of the bracket and a fastening groove formed in the protrusion. The fastening groove may be fastened to a fastening boss formed on a side face of the component. The fourth plate may be in contact with an assembly guide formed on the side face of the component.

The fourth plate may be in contact with a first assembly guide formed on a housing side face of the component in a direction corresponding to a direction perpendicular to an insertion direction in which the bracket is inserted into the mid-frame assembly and a second assembly guide formed on the housing side face of the component in a direction corresponding to the insertion direction.

A length of the first assembly guide may be less than or equal to half a length of the second assembly guide.

A protrusion that protrudes toward the inner side of the bracket and extends from the first plate through the first bent portion to the second plate may be included.

The first plate may include at least two fastening grooves formed to face each other with the protrusion therebetween, and may be fastened to the mid-frame assembly through the at least two fastening grooves and fastening grooves formed in both side faces of the mid-frame assembly.

The first plate may include a fastening groove to be fastened to the tail frame assembly and the mid-frame assembly.

The first plate and the third plate may be formed to be at least partially in contact with a side face of the mid-frame assembly and fastened to the mid-frame assembly.

The third plate may include two fastening grooves to be fastened to the mid-frame assembly, and a protrusion formed to protrude toward the inner side of the bracket and located between the two fastening grooves.

The at least one component may include an inverter, and the second plate may include a protrusion that protrudes toward the inner side of the bracket and a fastening groove configured to be fastened to at least one fastening boss formed on a side face of the inverter.

The connector may include at least one through-hole through which an electric wire passes.

The at least one through-hole may include a first through-hole and a second through-hole having an area at least twice an area of the first through-hole, and electric wires passing through the first through-hole and the second through-hole may be connected to different electric loads fastened to the tail assembly.

The at least one component may include a battery and an inverter, and the battery and the inverter may be fastened to the bracket to be spaced apart from each other.

The connector may include a protrusion that protrudes toward an inside of the bracket and is formed in a longitudinal direction of the connector.

The front frame assembly and the mid-frame assembly may be formed of a metal material, the tail frame assembly may include a tail frame and a rear wheel frame, the tail frame may be formed of a plastic material, and the rear wheel frame and the bracket may be formed of a steel material.

The bracket may include a connector disposed to face the rear face of the mid-frame assembly, a fifth plate that extends from the connector and faces a first plate, a fourth bent portion that extends from the fifth plate and is bent toward an inner side of the bracket, a sixth plate that extends from the fourth bent portion and faces a second plate, a fifth bent portion that extends from the sixth plate and is bent toward an outer side of the bracket, a seventh plate that extends from the fifth bent portion and faces a third plate, a sixth bent portion that extends from the seventh plate and is bent toward the inner side of the bracket, and an eighth plate that extends from the sixth bent portion and faces a fourth plate.

The at least one component may include an inverter, and the sixth plate may include a protrusion that protrudes toward the inner side of the bracket and fastening grooves configured to be fastened to at least two hooks formed on different side faces of the inverter.

To achieve the above-described goals, an electric mobility apparatus according to an example embodiment of the present disclosure includes a handlebar manipulated by a user, a display coupled to the handlebar and configured to display information associated with the electric mobility apparatus, a front wheel, a rear wheel, a support shaft having one side coupled to the display and the other side coupled to the front wheel, a mid-frame assembly in which a bracket fastened to at least one component to fix a position of the component is mounted, a front frame assembly having a portion inserted into a front face of the mid-frame assembly so as to be coupled to the mid-frame assembly, and a tail frame assembly having a portion inserted into a rear face of the mid-frame assembly so as to be coupled to the mid-frame assembly.

The bracket may include a first fastening arm that forms at least one uneven portion and is fastened to one side of the component inwardly, a second fastening arm that faces the first fastening arm, forms at least one uneven portion, and is fastened to the other side of the component inwardly, and a connector configured to connect the first fastening arm and the second fastening arm.

The bracket may include a connector disposed to face the rear face of the mid-frame assembly, a first plate formed to extend from the connector, a first bent portion that extends from the first plate and is bent toward an inner side of the bracket, a second plate formed to extend from the first bent portion, a second bent portion that extends from the second plate and is bent toward an outer side of the bracket, a third plate formed to extend from the second bent portion, a third bent portion that extends from the third plate and is bent toward the inner side of the bracket, and a fourth plate formed to extend from the third bent portion.

The fourth plate may include a protrusion that protrudes toward the outer side of the bracket and a fastening groove formed in the protrusion. The fastening groove may be fastened to a fastening boss formed on a side face of the component. The fourth plate may be in contact with an assembly guide formed on the side face of the component.

The fourth plate may be in contact with a first assembly guide formed on a housing side face of the component in a direction corresponding to a direction perpendicular to an insertion direction in which the bracket is inserted into the mid-frame assembly and a second assembly guide formed in a direction corresponding to the insertion direction.

A length of the first assembly guide may be less than or equal to half a length of the second assembly guide.

A protrusion that protrudes toward the inner side of the bracket and extends from the first plate through the first bent portion to the second plate may be included.

The first plate may include at least two fastening grooves formed to face each other with the protrusion therebetween.

The first plate may include a fastening groove to be fastened to the tail frame assembly and the mid-frame assembly.

The first plate and the third plate may be formed on a same plane and fastened to the mid-frame assembly.

The third plate may include two fastening grooves to be fastened to the mid-frame assembly, and a protrusion formed to protrude toward the inner side of the bracket and located between the two fastening grooves.

The at least one component may include an inverter, and the second plate may include a protrusion that protrudes toward the inner side of the bracket and a fastening groove configured to be fastened to at least one fastening boss formed on a side face of the inverter.

The bracket may include a connector disposed to face the rear face of the mid-frame assembly, a fifth plate that extends from the connector and faces a first plate, a fourth bent portion that extends from the fifth plate and is bent toward an inner side of the bracket, a sixth plate that extends from the fourth bent portion and faces a second plate, a fifth bent portion that extends from the sixth plate and is bent toward an outer side of the bracket, a seventh plate that extends from the fifth bent portion and faces a third plate, a sixth bent portion that extends from the seventh plate and is bent toward the inner side of the bracket, and an eighth plate that extends from the sixth bent portion and faces a fourth plate.

The at least one component may include an inverter, and the sixth plate may include a protrusion that protrudes toward the inner side of the bracket and fastening grooves configured to be fastened to at least two hooks formed on different side faces of the inverter.

Details of other example embodiments are included in the detailed descriptions and drawings.

### Effects

According to example embodiments of the present disclosure, one or more of the following effects can be achieved.

First, it is possible to improve a convenience of assembly by using a bracket when assembling the electric mobility apparatus including a front frame assembly, a mid-frame assembly, and a tail frame assembly.

Further, when a bracket for fixing positions of internal components is used, a convenience of screw fastening may be increased through the fixing of positions, which may lead to a reduction in time required for assembly and an improvement in productivity of an electric mobility apparatus.

Further, it is possible to improve a convenience of fastening a bracket and components using an assembly guide that functions as a stopper and support.

Further, a first fastening arm, a connector, and a second fastening arm included in a bracket may each include a protrusion protruding toward an inner side or an outer side of the bracket so that a strength of the bracket is reinforced.

Further, it is possible to form a body frame, which is sate from a shock generated during driving of an electric mobility apparatus, using manufacturing methods and materials suitable for a front frame assembly, a mid-frame assembly, and a tail frame assembly.

Effects are not limited to the aforementioned effects, and other effects not mentioned will be clearly understood by those skilled in the art from the description of the claims.

### BRIEF DESCRIPTION OF DRAWINGS

FIG. 1 is a perspective view illustrating an electronic mobility apparatus according to an example embodiment.

FIG. 2 is a side view illustrating an electric mobility apparatus according to an example embodiment.

FIG. 3A is a perspective view illustrating a body frame according to an example embodiment. FIG. 3B is an exploded side view illustrating a body frame according to an example embodiment.

FIG. 4A is a front view illustrating a front frame assembly according to an example embodiment, FIG. 4B is a right-side view illustrating a front frame assembly according to an example embodiment, FIG. 4C is a rear view illustrating a front frame assembly according to an example embodiment, and FIG. 4D is a perspective view illustrating a front frame assembly according to an example embodiment.

FIG. 5A is a perspective view illustrating a mid-frame assembly decoupled from a support stand according to an example embodiment and FIG. 5B is a right-side view illustrating a mid-frame assembly coupled to a support stand according to an example embodiment.

FIG. 6 is a view illustrating an example of coupling a mid-frame assembly and a bracket according to an example embodiment.

FIG. 7A is a perspective view illustrating a bracket according to an example embodiment, FIG. 7B is a plan view illustrating a bracket according to an example embodiment, FIG. 7C is a right-side view illustrating a bracket according to an example embodiment, and FIG. 7D is a rear view illustrating a bracket according to an example embodiment.

FIG. 8A is a perspective view illustrating a bracket and a component fastened to the bracket according to an example embodiment, FIG. 8B is a plan view illustrating a bracket and a component fastened to the bracket according to an example embodiment, FIG. 8C is an enlarged view illustrating an assembly guide formed on a side face of a component according to an example embodiment, and FIG. 8D is an enlarged view illustrating a bracket in contact with an assembly guide according to an example embodiment.

FIG. 9A is a right-side view illustrating a tail frame assembly according to an example embodiment, FIG. 9B is a rear view illustrating a tail frame assembly according to an example embodiment, and FIG. 9C is a perspective view illustrating a tail frame assembly according to an example embodiment.

FIG. 10A is a plan view illustrating a tail frame according to an example embodiment, FIG. 10B is a perspective view illustrating a tail frame according to an example embodiment, FIG. 10C is a front view illustrating a tail frame according to an example embodiment, and FIG. 10D is a rear view illustrating a tail frame according to an example embodiment.

FIG. 11A is a perspective view illustrating a rear wheel frame according to an example embodiment, FIG. 11B is a plan view illustrating a rear wheel frame according to an example embodiment, and FIG. 11C is a right-side view illustrating a rear wheel frame according to an example embodiment.

### BEST MODE FOR CARRYING OUT THE INVENTION

Hereinafter, example embodiments of the present disclosure will be described in detail with reference to the accompanying drawings.

The same or similar components may be given the same reference numerals regardless of the reference numerals, and redundant description thereof may be omitted. With respect to constituent elements used in the following description, suffixes “module” and “unit” are given or mingled with each other only in consideration of ease in the preparation of the specification, and do not have or serve as different meanings. Also, in the description of embodiments, detailed description of well-known arts will be omitted when it is deemed that such description will cause ambiguous interpretation of the present disclosure. In addition, the accompanying drawings are only for easy understanding of the embodiments disclosed in the present specification, and the technical ideas disclosed in the present specification are not limited by the accompanying drawings. Also, it should be understood to cover all modifications, equivalents, and alternatives falling within the spirit and scope of the present specification.

Although terms such as “first” and “second” may be used herein to describe various elements, these elements are not to be limited by these terms. Rather, these terms are only used to distinguish one element from another element.

When an element is described as being “connected to” or “coupled to” another element, it may be directly “connected to” or “coupled to” the other element, or there may be other elements intervening therebetween. In contrast, when an element is described as being “directly connected” or “directly coupled to” another element, there can be no other elements intervening therebetween.

The singular forms are intended to include the plural forms as well, unless the context clearly indicates otherwise.

In the present specification, it will be further understood that the terms “comprises” or “includes”, when used herein, specify the presence of stated features, integers, steps, operations, elements, components, or combinations thereof, but do not preclude the presence or addition of one or more other features, integers, steps, operations, elements, components, or combinations thereof.

In describing the example embodiments, descriptions of technical contents that are well known in the art to which the present disclosure belongs and are not directly related to the present specification will be omitted. This is to more clearly communicate without obscuring the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the present disclosure and methods of achieving them will be apparent from the following example embodiments that will be described in more detail with reference to the accompanying drawings. It should be noted, however, that the present disclosure is not limited to the following example embodiments, and may be implemented in various forms. Accordingly, the example embodiments are provided only to disclose the present disclosure and let those skilled in the art know the category of the present disclosure. In the drawings, embodiments of the present disclosure are not limited to the specific examples provided herein and are exaggerated for clarity. The same reference numerals or the same reference designators denote the same elements throughout the specification.

In addition, the description may be given by giving different reference numerals in different drawings for the same components throughout the specification.

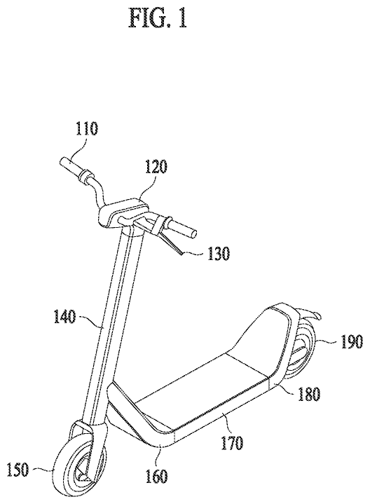

FIG. 1 is a perspective view illustrating an electronic mobility apparatus according to an example embodiment.

FIG. 1 illustrates components included in an electric mobility apparatus.

An electric mobility apparatus may include at least one of a handlebar 110, a display 120, a brake lever 130, a support shaft 140, a front wheel 150, a front frame assembly 160, a mid-frame assembly 170, a tail frame assembly 180, and a rear wheel 190.

The handlebar 110 may be manipulated by a user so that a direction of the electric mobility apparatus is changed. In addition, an acceleration input may be received based on the handlebar 110 manipulated by the user. Based on the acceleration input, a speed of the electric mobility apparatus may be adjusted. For example, when the user pulls or rotates the handlebar 110 in a predetermined direction, the electric mobility apparatus may be accelerated, and the user may move the handlebar 110 to change the direction of the electric mobility apparatus.

The display 120 may display information associated with the electric mobility apparatus. For example, the display 120 may display various information such as a current speed, an amount of charge remaining in a battery, whether the user is authenticated, a vehicle status, a speed limitation, power on/off, communication module-related operation information, accelerating torque-related information, decelerating torque-related information, braking charging-related information, and the like of the electric mobility apparatus.

The handlebar 110 and the display 120 may be coupled to the support shaft 140. In addition, the support shaft 140 may be coupled to the front wheel 150 and the front frame assembly 160. At this time, the support shaft 140 may be fastened to the front frame assembly 160 by penetrating the front frame assembly 160.

A communication module to be mounted in the electric mobility apparatus may transmit and receive data to and from external devices using wired or wireless communication. The communication module may employ communication technologies such as a global system for mobile communication (GSM), code division multi access (CDMA), long-term evolution (LTE), fifth generation (5G), wireless LAN (WLAN), wireless-fidelity (Wi-Fi), Bluetooth™, radio frequency identification (RFID), Infrared Data Association (IrDA), ZigBee, near field communication (NFC), and the like. The electric mobility apparatus may use the communication module to perform communication with at least one of another electric mobility apparatus, a mobile terminal, a base station, an access point (AP), and infrastructure.

In response to the brake lever 130 being manipulated by the user, the speed of the electric mobility apparatus may be reduced. The brake lever 130 may be connected to at least one of both side handlebars. For example, in response to the brake lever 130 being manipulated, a mechanical braking force may be applied to at least one of the front wheel 150 and the rear wheel 190. According to an example embodiment, the user may control the brake lever 130 to cause mechanical braking so that the speed of the electric mobility apparatus may be reduced. As an example, based on the manipulation of the brake lever 130, a portion of the front wheel 150 may contact a brake pad, so that the braking force is generated by friction.

The front wheel 150 mechanically braked by the brake lever 130 is merely an example, and the rear wheel 190 may be braked by the brake lever 130. As another example, in response to the brake lever 130 being manipulated, an electrical braking force may be applied to at least one of the front wheel 150 and the rear wheel 190. When a motor connected to at least one of the front wheel 150 and the rear wheel 190 rotates, controlling an inverter to brake the rotation of the motor may be electrical braking. The electrical braking may include at least one of regenerative braking for charging a battery with electrical energy generated based on the inverter control, power generation braking that converts the generated electrical energy into heat energy and consumes the same, and redundant braking that turns off all switches of the inverter. According to an example embodiment, in response to the manipulation of the brake lever 130, the mechanical braking for the front wheel 150 and the electrical braking for the rear wheel 190 may be applied together.

A movement of the front wheel 150 may be determined based on the handlebar 110 manipulated by the user. In addition, a rotational speed of the front wheel 150 may be reduced through mechanical braking by the brake lever 130.

Since the rear wheel 190 receives power from the motor connected to the inverter, the speed of the rear wheel 190 may be increased by the motor. In addition, the rotational speed of the rear wheel 109 may be reduced by electrical braking. The speed of the electric mobility apparatus may be reduced through the reduction of the rotational speed of the front wheel 107 or the rear wheel 109. Here, the motor may be a brushless direct current motor (BLDC), an induction motor, or a reluctance motor or include a driving and regenerative braking type electric motor (for example, both a motor and a generator).

A body frame may serve as a support plane related to the user getting on a vehicle. Components (for example, a battery, a controller, an inverter, and the like) may be mounted in the body frame so that the mounted components are protected from external shock. The body frame may be formed by coupling with at least one of the front frame assembly 160, the mid-frame assembly 170, and the tail frame assembly 180.

One side of the front frame assembly 160 may be coupled to the support shaft 140. The other side of the front frame assembly 160 may be partially inserted into a front face of the mid-frame assembly 170. An upper end of the mid-frame assembly 170 may be a boarding part on which the user is to be located and serve as the support plane. A portion of the tail frame assembly 180 may be inserted into a rear face of the mid-frame assembly 170. The front frame assembly 160, the mid-frame assembly 170, and the tail frame assembly 180 will be described in detail later.

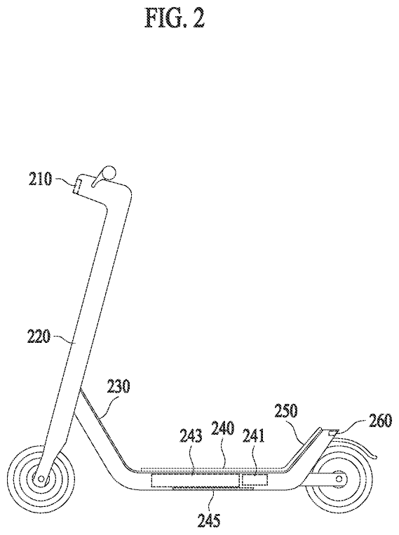

FIG. 2 is a side view illustrating an electric mobility apparatus according to an example embodiment.

FIG. 2 illustrates components mounted or attached to an electric mobility apparatus.

A front lamp 210 may emit light illuminating an area in front of the electric mobility apparatus during driving. In addition, a rear lamp 260 may emit light illuminating an area behind the electric mobility apparatus during driving. Also, according to an example embodiment, a bottom lamp 245 attached to a bottom of the body frame may be included. The bottom lamp 245 may emit light to a road on which the electric mobility apparatus travels. At least one of the front lamp 210, the rear lamp 260, and the bottom lamp 245 may be connected to a battery to receive power.

A support shaft 220 may be coupled to a front frame assembly 230. At this time, an electric wire connecting the battery and the front lamp 210 may pass through the support shaft 220. In addition, electric wires related to a display, a handlebar, and a communication module may pass through the support shaft 220.

A portion of the front frame assembly 230 may be inserted into a front face of a mid-frame assembly 240. A portion of a tail frame assembly 250 may be inserted into a rear face of the mid-frame assembly 240. The mid-frame assembly 240 may include components (for example, a battery, an inverter, a controller, and the like) therein. For example, an inverter 241 and a battery housing 243 may be included in the mid-frame assembly 240.

The inverter 241 may control a rotation of a motor based on a control of a controller. The battery housing 243 may include a battery and a battery management system (BMS) and protect the internal battery and BMS from external shock. The battery may include a plurality of battery cells and include a rechargeable battery pack. The battery may supply power to components such as the motor, the controller, the inverter, the communication module, the front lamp, the rear lamp, and the like.

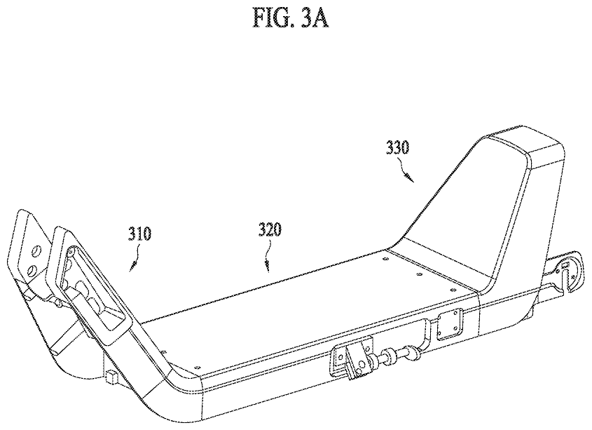

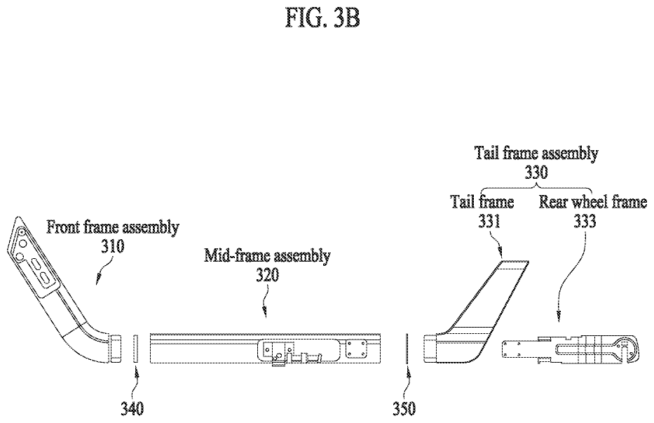

FIG. 3A is a perspective view illustrating a body frame according to an example embodiment and FIG. 3B is an exploded side view illustrating a body frame according to an example embodiment.

Referring to FIGS. 3A and 3B, a body frame may include at least one of a front frame assembly 310, a mid-frame assembly 320, and a tail frame assembly 330. At this time, a sealing member 340 may be provided between the front frame assembly 310 and the mid-frame assembly 320 to seal a gap therebetween. Through such sealing, a waterproofing effect may be achieved to prevent water from entering the mid-frame assembly. In addition, a sealing member 350 may be provided between the mid-frame assembly 320 and the tail frame assembly 330 to seal a gap therebetween. Likewise, through such sealing, the waterproofing effect may be achieved to prevent water from entering the mid-frame assembly. The sealing members 340 and 350 may prevent water from entering the frame so that the components in the body frame may be protected. In addition, by coupling the frames using the sealing members 340 and 350, noise generated between the frames may be reduced even when a force is applied to the electric mobility apparatus. In the example embodiment, the sealing member may be formed of an elastic material, for example, rubber.

One side of the front frame assembly 310 may be coupled to a support shaft. The other side of the front frame assembly 310 may be partially inserted into a front face of the mid-frame assembly 320. A portion of the tail frame assembly 330 may be inserted into a rear face of the mid-frame assembly 320. Accordingly, the body frame of the electric mobility apparatus may be formed by coupling the front frame assembly 310, the mid-frame assembly 320, and the tail frame assembly 330. The tail frame assembly 330 may include a tail frame 331 and a rear wheel frame 333. The rear wheel frame may pass through a slit of the tail frame to be inserted into the mid-frame assembly 320.

The front frame assembly 310, the mid-frame assembly 320, and the tail frame assembly 330 will be described in detail later.

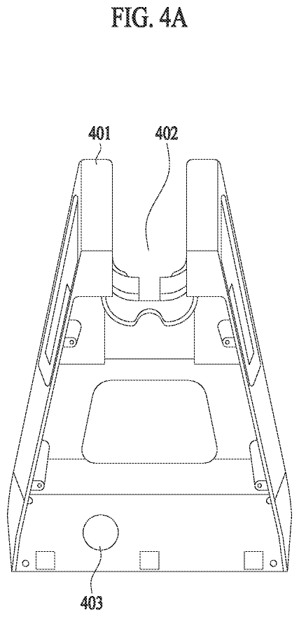

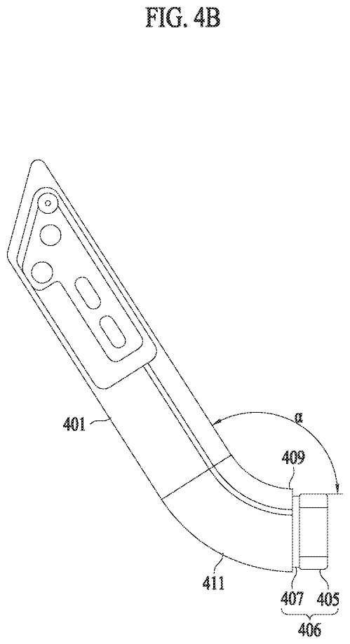

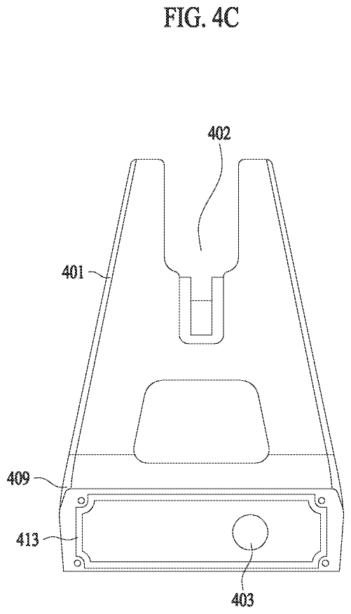

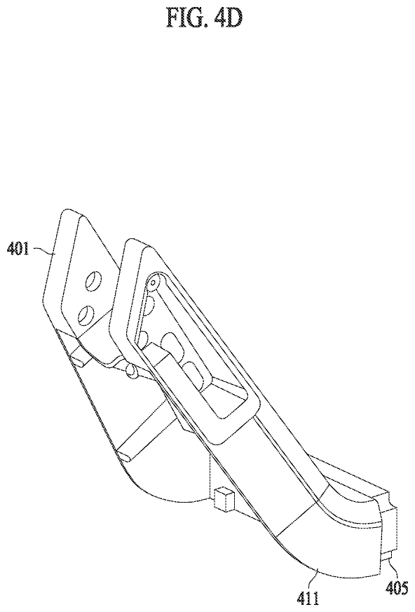

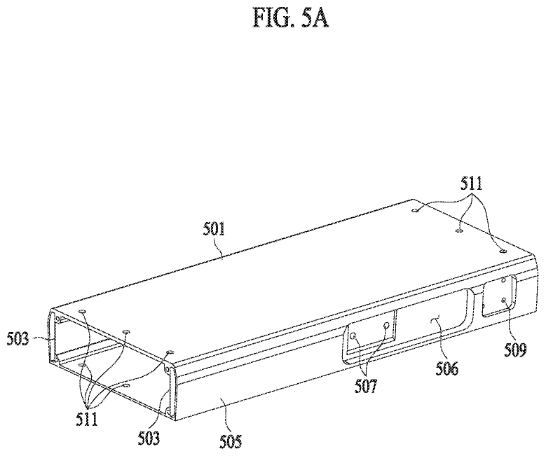

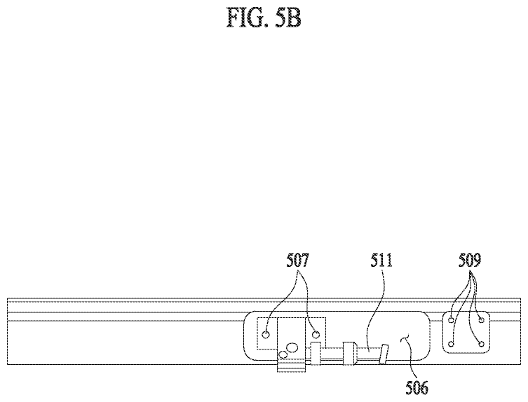

FIG. 4A is a front view illustrating a front frame assembly according to an example embodiment, FIG. 4B is a right-side view illustrating a front frame assembly according to an example embodiment, FIG. 4C is a rear view illustrating a front frame assembly according to an example embodiment, and FIG. 4D is a perspective view illustrating a front frame assembly according to an example embodiment.

Referring to FIGS. 4A and 4D, a front frame assembly may include a fastener 401 fastened to a steering assembly including a support shaft. The fastener 401 may include a groove 402 that the steering assembly passes through and seats therein. A shape of the groove may correspond to a shape of the steering assembly. The front frame assembly may include a hole 403 through which an electric wire passes. Electric wires connected to components (for example, a battery, an inverter, a controller, and the like) included in the mid-frame assembly may pass through the hole 403 to be connected to other components (for example, a display and a handlebar) of the electric mobility apparatus through the support shaft.

The front frame assembly may include at least one of the fastener 401, a bent portion 411, a planar portion 409, and a first connector 406. The first connector 406 may be inserted into a front face of the mid-frame assembly to be fastened to the mid-frame assembly. At this time, the first connector 406 may include a sealing groove 407 and a planar portion 405. A sealing member may be seated in the sealing groove 407. At this time, the planar portion 405 may be inserted into the front face of the mid-frame assembly, and the sealing member seated in the sealing groove 407 may be compressed when the mid-frame assembly is fastened to the front frame assembly. By inserting and fastening the first connector 406 to the front face of the mid-frame assembly, the front frame assembly may be more firmly coupled with the mid-frame assembly. Specifically, as the first connector 406 is inserted into the front face of the mid-frame assembly, a generated moment may be dispersed, which may lead to a more strong engagement. The first connector may be inserted into the mid-frame assembly such that a component (for example, the battery) included in the mid-frame assembly is spaced apart from the first connector at a predetermined distance.

A sealing member 413 may be seated in the sealing groove 407. Due to the waterproof effect achieved by the sealing member 413, components in the mid-frame assembly may be protected. At this time, the sealing groove 407 may be formed to a side opposite to a side at which the first connector 406 is inserted into the mid-frame assembly. In addition, the sealing groove 407 may be disposed between the planar portion 409 and the planar portion 405 so that the sealing member is seated at an end of a direction opposite to a direction in which the first connector 406 is inserted into the mid-frame assembly.

When coupled to the mid-frame assembly, the planar portion 409 may form a plane extending from an upper end of the mid-frame assembly. The bent portion 411 may extend from the planar portion 409 and be bent in a handlebar direction. One side of the bent portion 411 may be in contact with the planar portion 409. The other side of the bent portion 411 may be in contact with the fastener 401. At this time, an angle α between the fastener 401 and the planar portion 409 obtained by the bent portion 411 may be 90 degrees (°) or more. Specifically, the angle α between the fastener 401 and the first connector 405 obtained by the bent portion 411 may be ranged between 90° and 150°, inclusive.

The sealing member 413 may be seated in the sealing groove 407. At this time, a shape of the sealing member 413 may correspond to a shape of the first connector 406.

According to an example embodiment, the front frame assembly may be formed using a die-casting method. At this time, the front frame assembly may be formed of a lightweight metal material. For example, the front frame assembly may be formed based on a die-casting method using aluminum. Through this, the material cost may be reduced, and a strength may be reinforced while reducing the weight of the electric mobility apparatus.

FIG. 5A is a perspective view illustrating a mid-frame assembly decoupled from a support stand according to an example embodiment and FIG. 5B is a right-side view illustrating a mid-frame assembly coupled to a support stand according to an example embodiment.

FIGS. 5A and 5B illustrate a mid-frame assembly and a support stand coupled therewith. The mid-frame assembly may form a user boarding part on an upper end 501. For example, a cover may be disposed at the upper end 501 of the mid-frame assembly, so that a user gets on the cover.

The mid-frame assembly may include at least one fastening groove 511. The at least one fastening groove 511 may be formed in at least one of an upper end and a lower end of the mid-frame assembly to fasten a first connector and a second connector. Specifically, the fastening groove 511 may be used to fasten the upper end of the mid-frame assembly and a first connector of a front frame assembly or a second connector of a tail frame assembly. Alternatively, the fastening groove 511 may be used to fasten the lower end of the mid-frame assembly and the first connector of the front frame assembly or the second connector of the tail frame assembly. In the example embodiment, the first connector and the second connector may have grooves corresponding to the fastening groove 511 when inserted into the mid-frame assembly so that a fastening member is inserted through the fastening grooves and then coupled to the mid-frame assembly. In the overall example embodiment, coupling through the fastening groove may indicate that the fastening member is inserted through the fastening groove so that at least one element is coupled to another element. In the example embodiment, the fastening member may include a screw, a nail, a rivet, and the like, and may include any fastening member generally used in the fastening groove.

A guide 503 may be formed on both inner side faces of the mid-frame assembly in a longitudinal direction of the mid-frame assembly. An insertion passage may be formed between the guide 503 and each of the inner side faces of the mid-frame assembly, and an extension fastener of the tail frame assembly may be inserted into the insertion passage. For example, the insertion passage to which the extension fastener is to be inserted may be formed between the guide 503 and one side face 505. At this time, a length to which the extension fastener is inserted into the mid-frame assembly may be at least twice when compared to the second connector. For example, a length to which the extension fastener is inserted into the mid-frame assembly may be at least twice a length to which the second connector is inserted into the mid-frame assembly.

The one side face 505 of the mid-frame assembly may have a hole 506 so that a portion of the guide 503 is exposed outside through the hole 506. A support stand 513 may be fastened at a position corresponding to the hole 506, and the support stand 513 may be fastened to the guide 503 using at least one fastening groove 507. Here, the support stand 513 may be bent toward a bottom of the mid-frame assembly by an external force when the electric mobility apparatus is stopped, thereby supporting the electric mobility apparatus. At this time, the fastening groove 507 may be formed on an outer side face of the guide 503. In addition, the fastening groove 507 may be fastened to the support stand 513, and simultaneously, fastened to a bracket mounted in the mid-frame assembly. As such, by fastening the support stand 513 and the bracket together through the fastening groove 507, it is possible to improve an assembly and durability of components coupled in the electric mobility apparatus.

A fastening groove 509 may be formed on at least one of the guide 503 and both side faces including the one side face 505 of the mid-frame assembly. Using the fastening groove 509, the extension fastener of the tail frame assembly and the mid-frame assembly may be fastened. Here, the number of the fastening grooves 507 and 509 and positions of the same shown in FIG. 5A are provided as merely an example, and the example is not to be taken as being limited thereto.

According to an example embodiment, the mid-frame assembly may be formed based on an extrusion method. The extrusion method may be relatively advantageous compared to a die casting method in terms of costs and strength. At this time, like the front frame assembly, the mid-frame assembly may be formed of a lightweight metal material. For example, the mid-frame assembly may be formed based on an extrusion method using aluminum. From this, the material cost may be reduced and the strength may be reinforced while reducing the weight of the electric mobility apparatus.

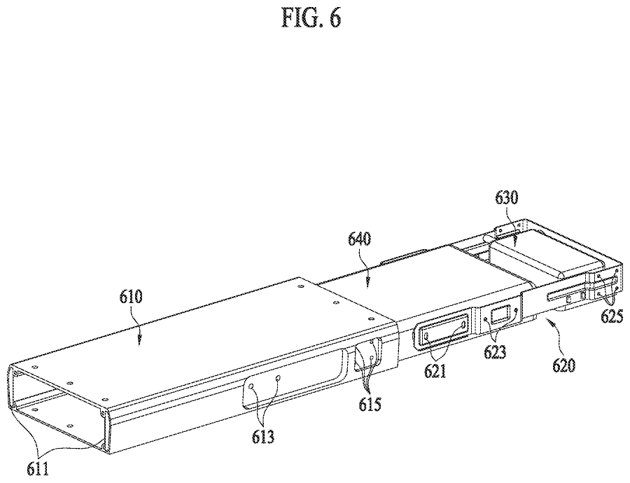

FIG. 6 is a view illustrating an example of coupling a mid-frame assembly and a bracket according to an example embodiment.

Referring to FIG. 6, a bracket 620 may be inserted into a mid-frame assembly 610 and mounted therein. At this time, the mid-frame assembly 610 may include a guide 611 and one or more fastening grooves 613 and 615 formed on the guide 611. In the example embodiment, each of the fastening grooves 613 and 615 may be exposed to an outside through a hole formed on a side face of the mid-frame assembly 610. The fastening grooves 613 and 615 may be exposed to the outside through different holes. Meanwhile, two fastening grooves 613 and four fastening grooves 615 shown in FIG. 6 are provided as merely an example, and the number of fastening grooves is not limited to the examples shown in the drawings.

The bracket 620 may be fastened to at least one component. In response to the bracket 620 being fixed to the mid-frame assembly 610, a position at which the component is fastened to the bracket 620 may be fixed. For example, a battery housing 640 and an inverter 630 may be fastened to the bracket 620, so that positions of the battery housing 640 and the inverter 630 are fixed. Specifically, a fastening boss formed on a side face of the battery housing 640 may be fastened to a fastening groove 621 formed on the bracket 620, and a fastening boss formed on a side face of the inverter 630 may be fastened to a fastening groove formed on the bracket 620. In addition, a fastening boss formed on another side face of the battery housing 640 may be fastened to a fastening groove formed on the bracket 620, and a hook formed on another side face of the inverter 630 may be inserted into a fastening groove formed on the bracket 620. Through this, the inverter 630 may be fastened to the bracket.

The bracket 620 may be mounted on the mid-frame assembly 610 and disposed to be in contact with an inner side face of the guide 611. The bracket 620 may be fastened to both inner side faces of the mid-frame assembly 610 so that a position of the bracket 620 is fixed in the mid-frame assembly. For example, the bracket 620 may be fastened to the fastening grooves 613 and 615 formed on the guide 611 of the mid-frame assembly 610. Specifically, a fastening groove 623 of the bracket 620 may be fastened to the fastening groove 613 of the mid-frame assembly 610, and a fastening groove 625 of the bracket 620 may be fastened to the fastening groove 615 of the mid-frame assembly 610.

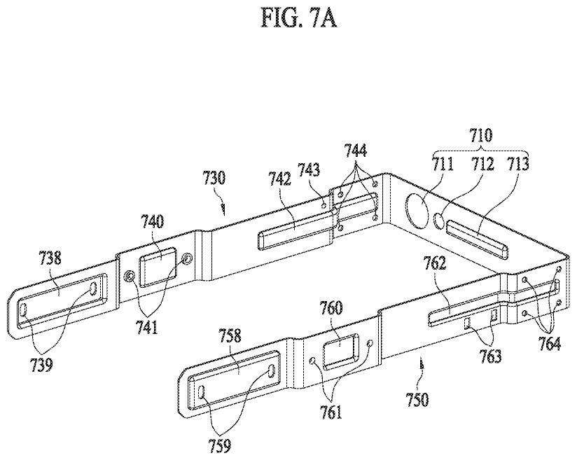

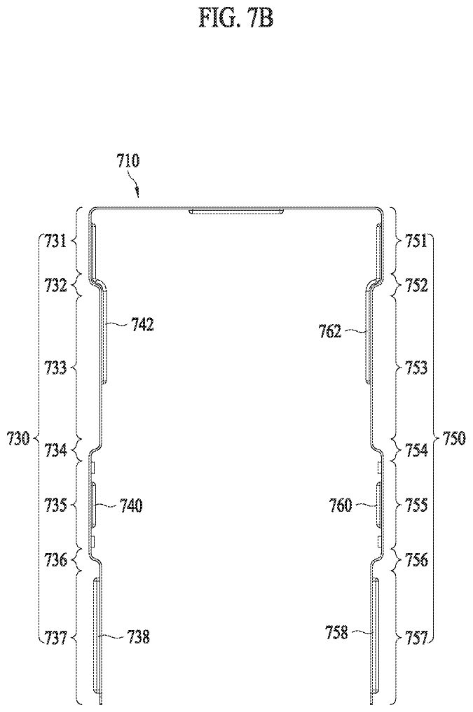

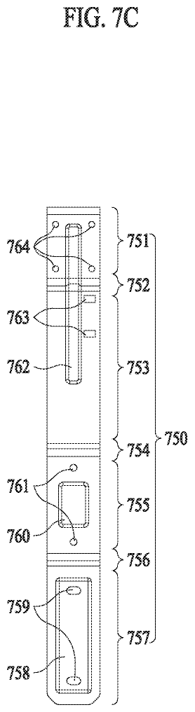

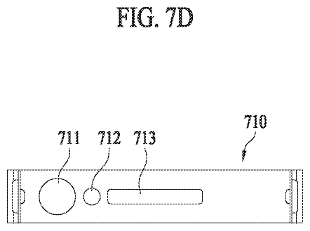

FIG. 7A is a perspective view illustrating a bracket according to an example embodiment, FIG. 7B is a plan view illustrating a bracket according to an example embodiment, FIG. 7C is a right-side view illustrating a bracket according to an example embodiment, and FIG. 7D is a rear view illustrating a bracket according to an example embodiment.

FIGS. 7A through 7D illustrate a structure of a bracket mounted in a mid-frame assembly.

A bracket may include a first fastening arm 730 that forms at least one uneven portion and has an inner side to which one side of a component is fastened. In addition, the bracket may include a second fastening arm 750 that faces the first fastening arm 730, forms at least one uneven portion, and has an inner side to which the other side of the component is fastened. In the example embodiment, the uneven portions of the first fastening arm 730 and the second fastening arm 750 may be formed to face each other. Also, the bracket may include a connector 710 connecting the first fastening arm 730 and the second fastening arm 750. When the bracket is mounted in the mid-frame assembly, the connector 710 may be disposed to face a rear face of the mid-frame assembly.

The first fastening arm 730 may include a first plate 731 formed to extend from the connector 710, a first bent portion 732 that extends from the first plate 731 and is bent toward an inner side of the bracket, a second plate 733 formed to extend from the first bent portion 732, a second bent portion 734 that extends from the second plate 733 and is bent toward an outer side of the bracket, a third plate 735 formed to extend from the second bent portion 734, a third bent portion 736 that extends from the third plate 735 and is bent toward the inner side of the bracket, and a fourth plate 737 formed to extend from the third bent portion 736. Here, the first plate 731 and the third plate 735 may be formed on a same plane and fastened to the mid-frame assembly. Specifically, the first plate 731 and the third plate 735 may be coupled while contacting guides formed on both side faces inside the mid-frame assembly. In addition, the second plate 733 and the fourth plate 737 may be formed on a same plane, so that a component such as a battery is disposed to be in contact with the second plate 733 and the fourth plate 737 therein.

Likewise, the second fastening arm 750 may include a fifth plate 751 that extends from the connector 710, a fourth bent portion 752 that extends from the fifth plate 751 and is bent toward the inner side of the bracket, a sixth plate 753 that extends from the fourth bent portion 752, a fifth bent portion 754 that extends from the sixth plate 753 and is bent toward the outer side of the bracket, a seventh plate 755 that extends from the fifth bent portion 754, a sixth bent portion 756 that extends from the seventh plate 755 and is bent toward the inner side of the bracket, and an eighth plate 757 that extends from the sixth bent portion 756. Here, the fifth plate 751 and the seventh plate 755 may be formed on a same plane and fastened to the mid-frame assembly. Specifically, the fifth plate 751 and the seventh plate 755 may be coupled to the mid-frame assembly while contacting guides formed on both side faces inside the mid-frame assembly. In addition, the sixth plate 753 and the eighth plate 757 may be formed on a same plane, so that a component such as a battery is disposed to be in contact with the sixth plate 753 and the eighth plate 757.

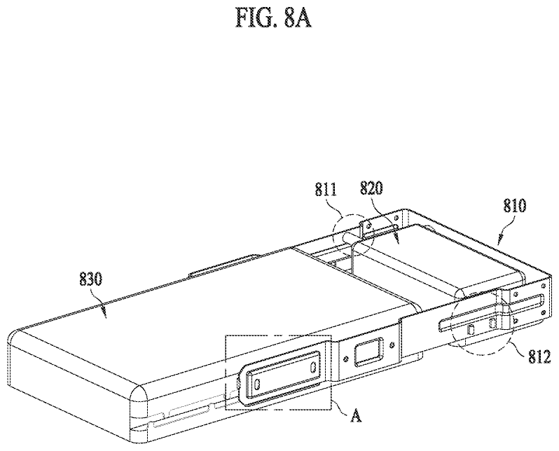

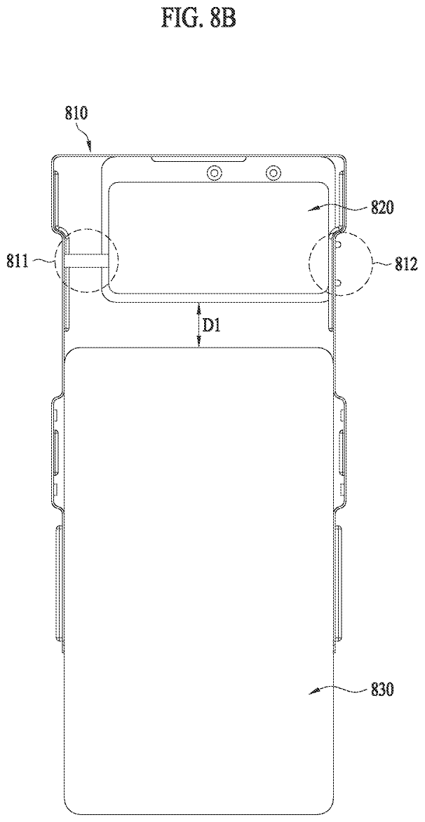

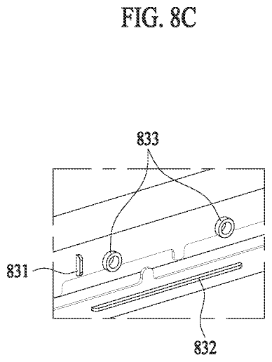

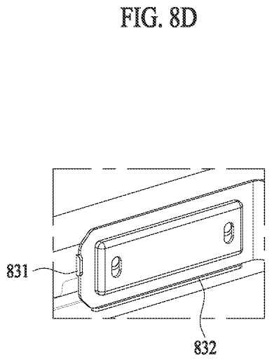

The fourth plate 737 may include a protrusion 738 that protrudes toward the outer side of the bracket and at least one fastening groove 739 formed on the protrusion 738. Here, the protrusion 738 may protrude to contact a fastening boss formed on a side face of a component coupled to an inside of the bracket. According to such structure of the protrusion 738, a strength of the fourth plate 737 may be reinforced. In addition, the fastening groove 739 may be fastened to the fastening boss formed on a side face of a component. Also, the fourth plate 737 may be in contact with an assembly guide formed on a side face of a component coupled to the inside of the bracket. For example, the fastening groove 739 may be fastened to a fastening boss formed on a side face of a battery housing, and the fourth plate 737 may be in contact with the first assembly guide and the second assembly guide formed on the side face of the battery housing. The assembly guide will be described in detail with reference to FIG. 8.

The third plate 735 may include two fastening grooves 741 to be fastened to the mid-frame assembly and a protrusion 740 located between the two fastening grooves 741 and protruding toward the inner side of the bracket. At this time, the strength of the bracket may be reinforced by the protrusion 740. For example, the fastening groove 741 may be fastened to a fastening groove 613 of the mid-frame assembly of FIG. 6. According to such fastening, a position of the bracket in the mid-frame assembly may be fixed.

The second plate 733 may include a fastening groove 743 to be fastened to a component and a protrusion 742 protruding toward the inner side of the bracket. At this time, the fastening groove 743 may be fastened to a fastening boss of the component. For example, the fastening groove 743 may be fastened to a fastening boss formed on a side face of an inverter. In addition, the protrusion 742 may protrude toward the inner side of the bracket to extend from the first plate 731 through the first bent portion 732 to the second plate 733. At this time, the strength of the bracket may be reinforced by the protrusion 742.

The first plate 731 may include at least two fastening grooves 744 formed to face each other with the protrusion 742 therebetween. For example, as shown in FIG. 7A, the four fastening grooves 744 may be formed on the first plate 731 to face one another with the protrusion 742 therebetween. At this time, the four fastening grooves 744 may be fastened to the fastening groove 615 of the mid-frame assembly of FIG. 6. Through this, the position of the bracket may be fixed in the mid-frame assembly. In addition, the fastening groove 744 may be fastened to the tail frame assembly. Specifically, the fastening groove 744 may be fastened to a fastening groove formed on an extension fastener of a rear wheel frame and the fastening groove of the mid-frame assembly. Through such fastening, it is possible to improve the assembly and reinforce the overall strength of the electric mobility apparatus.

The fifth plate 751 may be formed to face the first plate 731. Like the fastening groove 744, a fastening groove 764 may be fastened to other side faces of the mid-frame assembly and the tail frame assembly.

The sixth plate 753 may be formed to face the second plate 733, and like the protrusion 742, a protrusion 762 may protrude toward the inner side of the bracket. At this time, the strength of the bracket may be reinforced by the protrusion 762. Fastening grooves 763 may be fastened to at least two hooks formed on another side face of the inverter.

The seventh plate 755 may be formed to face the third plate 735, and may include two fastening grooves 731 to be fastened to the mid-frame assembly and a protrusion 760 located between the two fastening grooves 731 and protruding toward the inner side of the bracket. At this time, the strength of the bracket may be reinforced by the protrusion 760.

The eighth plate 757 may be formed to face the fourth plate 757, and may include a protrusion 758 protruding toward the outer side of the bracket and at least one fastening groove 759 formed on the protrusion 758. Here, the protrusion 758 may protrude to be in contact with a fastening boss formed on a side face of a component. According to such structure of the protrusion 758, the strength of the eighth plate 757 may be reinforced. In addition, the fastening groove 759 may be fastened to the fastening boss formed on the side face of the component. Also, the eighth plate 757 may be in contact with the assembly guide formed on the side face of the component.

The connector 710 may include at least one through-hole 711, 712 through which an electric wire passes and a protrusion 713. At this time, the protrusion 713 may protrude toward the inside of the bracket in a longitudinal direction of the connector 710. The overall strength of the connector 710 and the bracket may be reinforced by the protrusion 713.

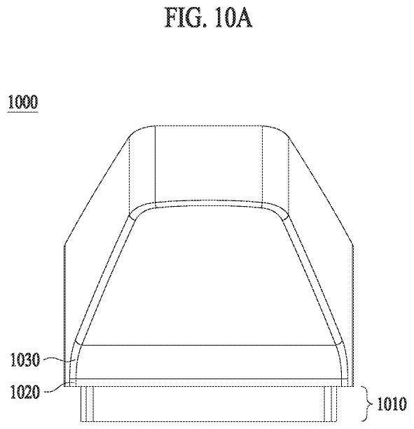

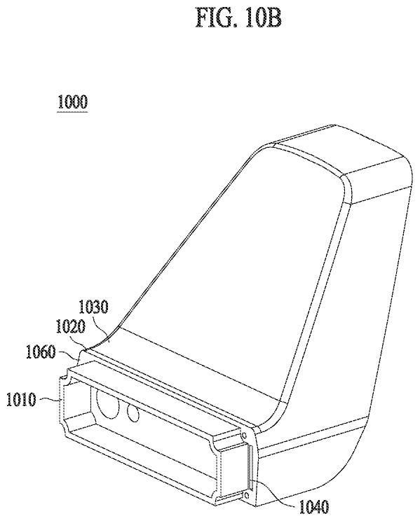

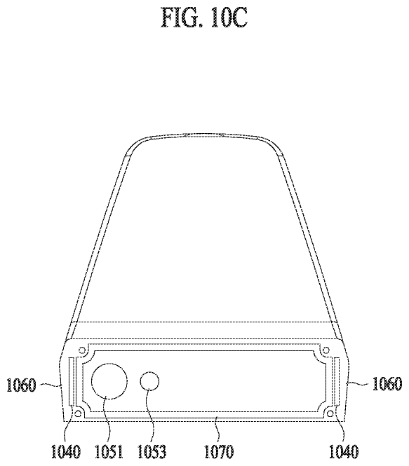

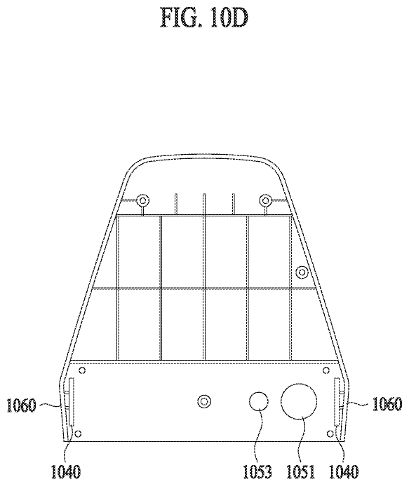

The through-hole may include a first through-hole 712 and a second through-hole 711. At this time, when compared to the first through-hole 712, the second through-hole 711 may have an area twice or more. Electric wires passing through the first through-hole 712 and the second through-hole 711 may be connected to different electric loads fastened to a tail assembly. For example, the electric wire passing through the second through-hole 711 may connect the inverter and a motor, and the electric wire passing through the first through-hole 712 may connect the battery and a rear lamp. At this time, the electric wires passing through the first through-hole 711 and the second through-hole 712 may pass a first through-hole 1051 and a second through-hole 1053 of a tail frame as shown in FIG. 10D.

FIG. 8A is a perspective view illustrating a bracket and a component fastened to the bracket according to an example embodiment, FIG. 8B is a plan view illustrating a bracket and a component fastened to the bracket according to an example embodiment, FIG. 8C is an enlarged view illustrating an assembly guide formed on a side face of a component according to an example embodiment, and FIG. 8D is an enlarged view illustrating a bracket in contact with an assembly guide according to an example embodiment.

Referring to FIG. 8A, a bracket 810 may be fastened to a component required for an electric mobility apparatus. For example, the bracket 810 may be fastened to a battery housing 830 and an inverter 820. At this time, to fasten the bracket 810 to the battery housing 830 easily, an assembly guide may be formed on a side face of the battery housing 830. Accordingly, while a fourth plate and an eighth plate of the bracket 810 are in contact with the assembly guide, the fourth plate and the eighth plate may be fastened to a fastening boss formed on the side face of the battery housing, so that a position of the battery housing is fixed. In addition, as indicated by reference numeral 811, the fastening boss formed on the side face of the inverter 820 may be fastened to a second plate of the bracket 810. Also, as indicated by reference numeral 812, a hook formed on another side face of the inverter 820 may be fastened to a sixth plate of the bracket 810. When the hook is used to fasten the fastening boss and the fastening groove instead of a screw, the assembly and productivity of the electric mobility apparatus may be improved, which may lead to a reduction in manufacturing costs.

Referring to FIG. 8B, the inverter 820 may be fastened to the bracket 810. As indicated by the reference numeral 811, a fastening boss formed on a side face of the inverter 820 may be fastened to a fastening groove formed on the second plate of the bracket 810. In addition, as indicated by the reference numeral 812, a hook formed on another side face of the inverter 820 may be fastened to a fastening groove formed on the sixth plate of the bracket 810. As described above, when the hook is used to fasten the fastening boss and the fastening groove instead of a screw, the assembly and productivity of the electric mobility apparatus may be improved, which may lead to a reduction in manufacturing cost.

At this time, a predetermined gap D1 between the inverter 820 and the battery housing 830 may be secured. The electric wires connected to the inverter 820 and the battery housing 830 may pass through through-holes formed on the connector of the bracket 810 using a room defined by D1.

FIGS. 8C and 8D show a part A of FIG. 8A enlarged. Referring to FIG. 8C, the assembly guide and the fastening boss may be formed on the side face of the battery housing. Referring to FIG. 8D, the bracket may be seated in the assembly guide.

The battery housing 830 may protect an internal battery from an external force. A first assembly guide 831 and a second assembly guide 832 may be formed on the side face of the battery housing 830. The first assembly guide 831 may be formed in a direction corresponding to a direction perpendicular to an insertion direction for insertion into the mid-frame assembly. The second assembly guide 832 may be formed in a direction corresponding to the insertion direction. Specifically, the first assembly guide 831 may perform a function of a stopper for the fourth plate or the eighth plate the bracket 810. The second assembly guide 832 may function to guide and support the fourth plate or the eighth plate of the bracket 810. Accordingly, by using the assembly guide, the battery housing 830 and the bracket 810 may be assembled with increased convenience. The first assembly guide 831 and the second assembly guide 832 may be formed on the side face of the battery housing 830. A length of the first assembly guide 831 may be less than or equal to half a length of the second assembly guide 832. The two assembly guides are shown as merely an example, and the present disclosure is not limited thereto. In some cases, one of the first assembly guide 831 and the second assembly guide 832 may be selectively provided. At least one fastening boss 833 formed on the side face of the battery housing 830 may be fastened to the fastening groove 759 of the eighth plate of FIG. 7. At this time, a position of the fastening boss 833 may correspond to a position of the fastening groove 759 and be determined in consideration of the eighth plate contacting the assembly guide 831, 832.

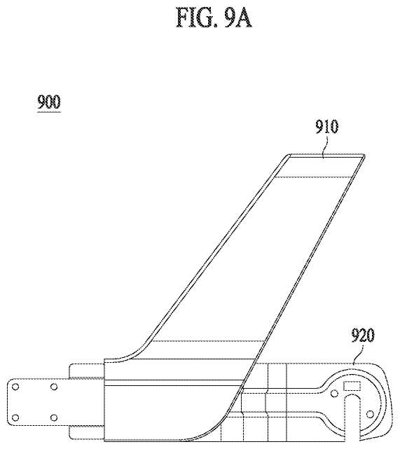

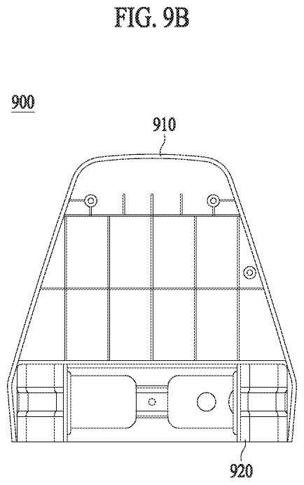

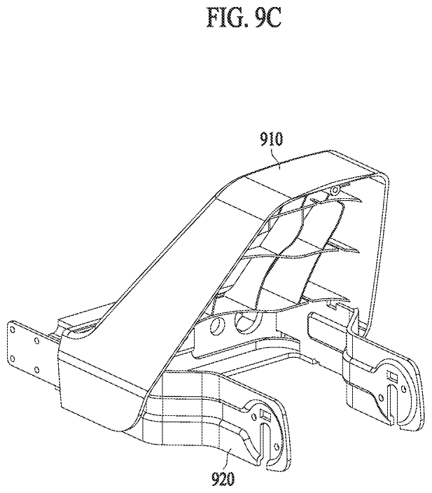

FIG. 9A is a right-side view illustrating a tail frame assembly according to an example embodiment, FIG. 9B is a rear view illustrating a tail frame assembly according to an example embodiment, and FIG. 9C is a perspective view illustrating a tail frame assembly according to an example embodiment.

FIGS. 9A through 9C illustrate a configuration of a tail frame assembly.

In the example embodiment, a tail frame assembly 900 may include a tail frame 910 and a rear wheel frame 920. At this time, the rear wheel frame 920 may pass through the tail frame 910 to be inserted into a mid-frame assembly. An extension fastener of the rear wheel frame 920 may be fastened to the mid-frame assembly. At least a portion of a second connector of the tail frame 910 may be inserted into a rear face of the mid-frame assembly. The tail frame 910 and the rear wheel frame 920 will be described in detail below.

FIG. 10A is a plan view illustrating a tail frame according to an example embodiment, FIG. 10B is a perspective view illustrating a tail frame according to an example embodiment, FIG. 10C is a front view illustrating a tail frame according to an example embodiment, and FIG. 10D is a rear view illustrating a tail frame according to an example embodiment.

FIGS. 10A through 10D illustrate a configuration of a tail frame 1000. The tail frame 1000 may include a second connector 1010 having at least a portion inserted into a rear face of a mid-frame assembly. When the second connector 1010 is inserted into the rear face of the mid-frame assembly and fastened thereto, the tail frame assembly and the mid-frame assembly may be more firmly coupled to each other. Specifically, when the second connector 1010 is inserted into the rear face of the mid-frame assembly, a moment generated by a force applied to the tail frame 1000 may be distributed so that the tail frame assembly and the mid-frame assembly are more firmly coupled. The second connector may be inserted into the mid-frame assembly such that a component (for example, an inverter) included in the mid-frame assembly is spaced apart from the second connector at a predetermined distance. In addition, the bracket fastened to the component may be mounted in the mid-frame assembly.

A planar portion 1020 may form a plane extending from an upper end of the mid-frame assembly when coupling to the mid-frame assembly. One side of a bent portion 1030 may extend from the planar portion 1020, and the other side may be bent in an upper-end direction. In addition, the tail frame 1000 may extend from the bent portion 1030 to be placed to cover one side of a rear wheel.

A tail frame may include at least one slit 1040 formed on an outer side of a plane on which the second connector 1010 protrudes. Specifically, the tail frame may include at least two slits 1040 formed on both side faces of the second connector 1010. An extension fastener of the rear wheel frame may pass through the slit 1040 to be inserted into the mid-frame assembly.

The tail frame may include a through-hole 1051, 1053 through which an electric wire passes. Specifically, the electric wire may pass through the through-hole 1051, 1053 to connect a component mounted on the mid-frame assembly and a rear wheel. For example, to connect an inverter of the mid-frame assembly and a motor mounted on the rear wheel, the electric wire may pass through at least one through-hole 1051, 1053. In this example, a first through-hole 1051 may have an area greater than that of a second through-hole 1053. For example, the first through-hole 1051 may have an area at least twice the area of the second through-hole 1053. Electric wires passing through the first through-hole 1051 and the second through-hole 1053 may be connected to different electric loads fastened to a tail assembly. For example, the electric wire connecting the inverter and the motor mounted on the rear wheel may pass through the first through-hole, and the electric wire connecting the battery and a rear lamp may pass through the second through-hole. In the example embodiment, the rear lamp may be seated behind the tail frame.

In addition, the rear wheel frame may include two wheel arms. On both sides, the tail frame may include side-face guides 1060 covering at least portions of the two wheel arms externally. The side-face guides 1060 on both sides of the tail frame may be formed to externally cover at least portions of the two wheel arms of the rear wheel frame passing through the slit 1040.

According to an example embodiment, the tail frame may be formed of a lightweight material to reduce product weight. Specifically, the tail frame may be formed using a plastic injection method, in which case a plastic material may be used. Through this, the material cost may be reduced and the weight of the electric mobility apparatus may be reduced.

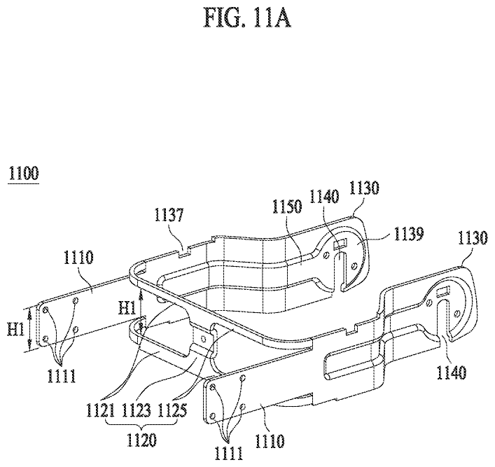

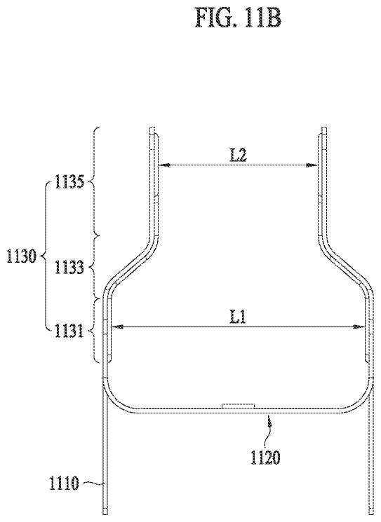

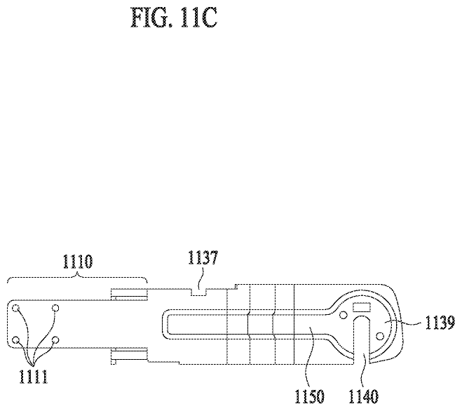

FIG. 11A is a perspective view illustrating a rear wheel frame according to an example embodiment, FIG. 11B is a plan view illustrating a rear wheel frame according to an example embodiment, and FIG. 11C is a left-side view illustrating a rear wheel frame according to an example embodiment.

Referring to FIGS. 11A through 11C, a rear wheel frame 1100 may include at least one of two wheel arms 1130, a first cut portion 1140, a bridge 1120, and an extension fastener 1110.

The extension fastener 1110 may be formed by cutting a portion of the bridge 1120. Specifically, in the rear wheel frame 1100, the extension fastener may be formed by cutting a portion of the bridge 1120 and bending based on a position at which the extension fastener 1100 is extended from and formed at the wheel arm 1130. For example, the rear wheel frame 1100 may be formed by bending a substantially fiat iron plate. In addition, the rear wheel frame 1100 may be formed in a manner of cutting a portion of the bridge 1120 as shown in the drawing and then bending a position at which the extension fastener 1100 is extended from and formed at the wheel arm 1130.

The bridge 1120 may include first bridges 1121 connected to one end of one of the two wheel arms 1130, second bridges 1125 connected to one end of a remaining one of the two wheel arms, and a bridge connector 1123. At this time, the bridge connector 1123 may be spaced apart from the two wheel arms and connect the first bridges 1121 and the second bridges 1125. At this time, a distance H1 between the first bridges 1121 may correspond to a width H1 of the extension fastener 1110. Likewise, a distance between the second bridges 1125 may correspond to a width of the extension fastener 1110. Specifically, since the extension fastener 1110 is formed by cutting a portion of the bridge 1120, the width H1 of the extension fastener 1110 may be equal to a distance separating the bridge 1120.

The first cut portion 1140 may be cut toward a lower end of the rear wheel frame 1100. A rear wheel shaft coupled to a rear wheel may be seated in the first cut portion 1140, and through this, may be coupled to the rear wheel frame 1100. At this time, the rear wheel shaft and the rear wheel frame 1100 may be formed on a metal material in consideration of the strength. Specifically, the rear wheel shaft and the rear wheel frame 1100 may have the same strength or strengths similar within a predetermined range to support each other. For example, the rear wheel shaft and the rear wheel frame 1100 may be formed of a material of galvanized iron.

The two wheel arms 1130 may be formed to face each other. The first cut portion 1140 in which the rear wheel shaft is seated may be cut and formed at the two wheel arms 1130. The two wheel arms 1130 may each include a wheel arm body 1131 connected to the bridge 1120, a bent portion 1133, and a shaft connector 1135 including the first cut portion 1140. Here, the bent portion 1133 may be located between the wheel arm body 1131 and the shaft connector 1135. In addition, the bent portion 1133 may be bent such that a distance between the shaft connectors 1135 of the two wheel arms 1130 is less than a distance between the wheel arm bodies 1131. Specifically, the bent portion 1133 may be bent such that a distance L2 between the shaft connectors 1135 is less than a distance L1 between the wheel arm bodies 1131. Specifically, the distance L2 may be determined based on a size of the rear wheel. In addition, the distance L2 may be determined to be greater than or equal to a predetermined percentage of the distance L1 to distribute a moment by the rear wheel and the rear wheel shaft. For example, to distribute the moment, the distance L2 may be determined to be 75% of the distance L1 or more.

The rear wheel frame 1100 may include the extension fastener 1110 that is inserted into the mid-frame assembly by passing through a slit of a tail frame. The extension fastener 1110 may include at least one fastening groove 1111 fastened to a side face of the mid-frame assembly. The fastening groove 1111 may be fastened to the fastening groove 509 formed on the side face of the mid-frame assembly.

The wheel arm 1130 may include a second cut portion 1137 in which a portion of the tail frame is seated on an upper end. When the rear wheel frame passes through the slit of the tail frame, the tail frame may be seated in the second cut portion 1137, which may lead to an increase in bonding force. The second cut portion 1137 may have a shape corresponding to a shape of the seated tail frame.

The wheel arm 1130 may include a recess 1139 formed around the first cut portion 1140 in an inward direction. A washer connected to the rear wheel shaft may be seated in the recess 1139. At this time, the recess 1139 may be shaped to protrude toward an inner side of the wheel arm 1130 to correspond to the washer.

A protrusion 1150 may be formed to protrude toward the inner side of the wheel arm 1130 throughout the wheel arm body 1131, the bent portion 1133, and the shaft connector 1135. One end of the protrusion 1150 may be connected to the recess 1139. A strength of the rear wheel frame may be reinforced by the protrusion 1150.

The above description is merely illustrative of the technical idea of the present disclosure, and those skilled in the art to which the present disclosure pertains may make various modifications and changes without departing from the essential quality of the present disclosure. Accordingly, the example embodiments disclosed herein are not intended to limit the technical spirit of the present disclosure but to describe the present disclosure, and the scope of the technical spirit of the present disclosure is not limited by the example embodiments. The scope of protection of the present disclosure should be interpreted by the following claims, and all technical ideas that fall within the scope of equivalents thereof should be construed as being included in the scope of the present disclosure.

1. An electric mobility apparatus comprising:
a mid-frame assembly in which a bracket fastened to at least one component is mounted on an inner side;
a front frame assembly having a portion inserted into a front face of the mid-frame assembly so as to be coupled to the mid-frame assembly; and
a tail frame assembly having a portion inserted into a rear face of the mid-frame assembly so as to be coupled to the mid-frame assembly,
wherein the bracket is fastened to both side faces inside the mid-frame assembly.

2. The electric mobility apparatus of claim 1, wherein the bracket comprises:
a first fastening arm that forms at least one uneven portion and is fastened to one side of the component inwardly;
a second fastening arm that faces the first fastening arm, forms at least one uneven portion, and is fastened to the other side of the component inwardly; and
a connector configured to connect the first fastening arm and the second fastening arm.

3. The electric mobility apparatus of claim 1, wherein the bracket comprises:
a connector disposed to face the rear face of the mid-frame assembly; and
a first plate formed to extend from the connector;
a first bent portion that extends from the first plate and is bent toward an inner side of the bracket;
a second plate formed to extend from the first bent portion;
a second bent portion that extends from the second plate and is bent toward an outer side of the bracket;
a third plate formed to extend from the second bent portion;
a third bent portion that extends from the third plate and is bent toward the inner side of the bracket; and
a fourth plate formed to extend from the third bent portion.

4. The electric mobility apparatus of claim 3, wherein the fourth plate comprises:
a protrusion that protrudes toward the outer side of the bracket; and
a fastening groove formed in the protrusion,
the fastening groove is fastened to a fastening boss formed on a side face of the component, and
the fourth plate is in contact with an assembly guide formed on the side face of the component.

5. The electric mobility apparatus of claim 3, wherein the fourth plate is in contact with a first assembly guide formed on a housing side face of the component in a direction corresponding to a direction perpendicular to an insertion direction in which the bracket is inserted into the mid-frame assembly and a second assembly guide formed on the housing side face of the component in a direction corresponding to the insertion direction, and
a length of the first assembly guide is less than or equal to half a length of the second assembly guide.

6. The electric mobility apparatus of claim 3, wherein the electric mobility apparatus comprises a protrusion that protrudes toward the inner side of the bracket and extends from the first plate through the first bent portion to the second plate, and
the first plate comprises at least two fastening grooves formed to face each other with the protrusion therebetween and is fastened to the mid-frame assembly through the at least two fastening grooves and fastening grooves formed in both side faces of the mid-frame assembly.

7. The electric mobility apparatus of claim 3, wherein the first plate comprises a fastening groove to be fastened to the tail frame assembly and the mid-frame assembly.

8. The electric mobility apparatus of claim 3, wherein the first plate and the third plate are formed to be at least partially in contact with a side face of the mid-frame assembly and fastened to the mid-frame assembly.

9. The electric mobility apparatus of claim 3, wherein the third plate comprises:
two fastening grooves configured to be fastened to the mid-frame assembly; and
a protrusion formed to protrude toward the inner side of the bracket and located between the two fastening grooves.

10. The electric mobility apparatus of claim 3, wherein the at least one component comprises a battery and an inverter,
the second plate comprises:
a protrusion that protrudes toward the inner side of the bracket; and
a fastening groove configured to be fastened to at least one fastening boss formed on a side face of the inverter, and
the battery and the inverter are fastened to the bracket to be spaced apart om each other.

11. The electric mobility apparatus of claim 2, wherein the connector comprises at least one through-hole through which an electric wire passes, and
the connector comprises a protrusion that protrudes toward an inside of the bracket and is formed in a longitudinal direction of the connector.

12. The electric mobility apparatus of claim 11, wherein the at least one through-hole comprises:
a first through-hole; and
a second through-hole having an area at least twice an area of the first through-hole, and
electric wires passing through the first through-hole and the second through-hole are connected to different electric loads fastened to the tail assembly.

13. The electric mobility apparatus of claim 1, wherein the front frame assembly and the mid-frame assembly are formed of a metal material,
the tail frame assembly comprises a tail frame and a rear wheel frame,
the tail frame is formed of a plastic material, and
the rear wheel frame and the bracket are formed of a steel material.

14. The electric mobility apparatus of claim 1, wherein the bracket comprises:
a connector disposed to face the rear face of the mid-frame assembly; and
a fifth plate that extends from the connector and faces a first plate;
a fourth bent portion that extends from the fifth plate and is bent toward an inner side of the bracket;
a sixth plate that extends from the fourth bent portion and faces a second plate;
a fifth bent portion that extends from the sixth plate and is bent toward an outer side of the bracket;
a seventh plate that extends from the fifth bent portion and faces a third plate;
a sixth bent portion that extends from the seventh plate and is bent toward the inner side of the bracket; and
an eighth plate that extends from the sixth bent portion and faces a fourth plate.

15. The electric mobility apparatus of claim 14, wherein the at least one component comprises an inverter, and
the sixth plate comprises:
a protrusion that protrudes toward the inner side of the bracket; and
fastening grooves configured to be fastened to at least two hooks formed on different side faces of the inverter.
